(19) United States
(12) Patent Application Publication
(10) Pub. No.: US 2023/0391311 A1
(43) Pub. Date: Dec. 7, 2023

(54) CONTROL APPARATUS FOR ELECTRIC VEHICLE AND METHOD OF CONTROLLING ELECTRIC VEHICLE

(71) Applicant: SUBARU CORPORATION, Tokyo (JP)

(72) Inventor: Tatsuhiko FUNASAKI, Tokyo (JP)

(21) Appl. No.: 18/318,244

(22) Filed: May 16, 2023

(30) Foreign Application Priority Data
Jun. 2, 2022 (JP) 2022-089987

(51) Int. Cl. B60W 20/10

(52) U.S. Cl. CPC B60W 20/10; B60W 2510/081; B60W 2552/15

(57) ABSTRACT

A control apparatus for an electric vehicle includes circuitry. The electronic control unit is configured to, upon determining that the electric vehicle is in a state in which the battery becomes unusable and is stopped on a slope, change an operation method of a drive motor of the electric vehicle to cause the drive motor to be directly operated by an electric power generated by an electric power generation motor of the electric vehicle without intervening a battery of the electric vehicle. The circuitry is configured to calculate an electric power amount necessary to start the electric vehicle in a climbing direction of the slope. The circuitry is configured to increase a rotational speed of an engine of the electric vehicle to cause the necessary electric power amount to be generated by the electric power generation motor.

### CROSS-REFERENCE TO RELATED APPLICATIONS

The present application claims priority from Japanese Patent Application No. 2022-089987 filed on Jun. 2, 2022, the entire contents of which are hereby incorporated by reference.

### BACKGROUND

The disclosure relates to a control apparatus for an electric vehicle and a method of controlling an electric vehicle.

Japanese Unexamined Patent Application Publication (JP-A) No. 2018-79790 discloses a hybrid vehicle including, for example, an engine, two motors, and a battery. The vehicle makes a transition to a battery-less traveling mode when, for example, the battery has a malfunction. In addition, the vehicle determines whether the vehicle slides down, based on, for example, a rotational speed of one of the motors that is directly coupled to drive wheels.

The vehicle stops a fuel injection of the engine when it is determined that the vehicle slides down in the battery-less traveling mode. Thereafter, the one of the motors is so driven and controlled that a torque in a direction corresponding to a shift position is outputted from the one of the motors by regenerative driving of the one of the motors.

The other one of the motors is so driven and controlled that electric power generated by the regenerative driving of the one of the motors is consumed as a heat without outputting a torque from the other one of the motors.

This configuration makes it possible to output the torque in the direction corresponding to the shift position (i.e., a direction in which the vehicle is prevented from sliding down) from the one of the motors, and thereby to suppress an increase in a speed of the sliding down of the vehicle.

### SUMMARY

An aspect of the disclosure provides a control apparatus for an electric vehicle. The electric vehicle is configured to store, in a battery, an electric power generated by an electric power generation motor driven by an engine, and configured to rotate a wheel to travel based on a drive force of the engine and a drive motor configured to operate on an as-necessary basis by an electric power outputted from the battery. The control apparatus for the electric vehicle includes an circuitry. The circuitry is configured to, upon determining that the electric vehicle is in a state in which the battery becomes unusable and is stopped on a slope, change an operation method of the drive motor to cause the drive motor to be directly operated by the electric power generated by the electric power generation motor without intervening the battery. The circuitry is configured to calculate an electric power amount necessary to start the electric vehicle in a climbing direction of the slope. The circuitry is configured to increase a rotational speed of the engine to cause the necessary electric power amount to be generated by the electric power generation motor.

An aspect of the disclosure provides a method of controlling an electric vehicle. The electric vehicle is configured to charge, to a battery, an electric power generated by an electric power generation motor driven by an engine, and configured to rotate a wheel to travel based on a drive force of the engine and a drive motor configured to operate on an as-necessary basis by an electric power stored in the battery. The method includes: determining whether the electric vehicle is stopped on a slope when the battery becomes unusable; when the electric vehicle is determined as being stopped on the slope, changing an operation method of the drive motor to cause the drive motor to be directly operated by the electric power generated by the electric power generation motor without intervening the battery; calculating an electric power amount necessary to start the electric vehicle in a climbing direction of the slope; and increasing a rotational speed of the engine to cause the necessary electric power amount to be generated by the electric power generation motor.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating an example of a configuration of an electric vehicle in which a control apparatus for an electric vehicle according to one example embodiment of the disclosure is mounted.

FIG. 2 is a flowchart illustrating an example of a control to be performed by the control apparatus.

FIG. 3 is a diagram describing that it takes a time for an electronically controlled coupling mechanism to be turned ON from OFF.

FIG. 4 is a diagram describing that the control apparatus increases a rotational speed of an engine in response to the degree of transition from OFF to ON of the electronically controlled coupling mechanism.

### DETAILED DESCRIPTION

A vehicle disclosed in JP-A No. 2018-79790 makes it possible to suppress an increase in a speed at the time of, for example, sliding down of the vehicle from a stopped state of the vehicle on a slope, when the vehicle is in a so-called battery-less traveling state due to, for example, a malfunction of the battery.

However, such a control method involves difficulties in so starting an electric vehicle as to travel up the slope even when the electric vehicle is in the battery-less traveling state.

It is desirable to provide a control apparatus for an electric vehicle and a method of controlling an electric vehicle that make it possible to so control the electric vehicle that is in a battery-less traveling state as to start in a climbing direction from a stopped state of the electric vehicle on a slope.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### [Configuration of Electric Vehicle]

Hereinafter, a configuration of an electric vehicle according to an example embodiment of the disclosure will be described.

The electric vehicle may store, in a battery, an electric power generated by an electric power generation motor driven by an engine, and may travel by rotating wheels based on power of the engine and power of a drive motor operated on an as-necessary basis by the electric power outputted from the battery.

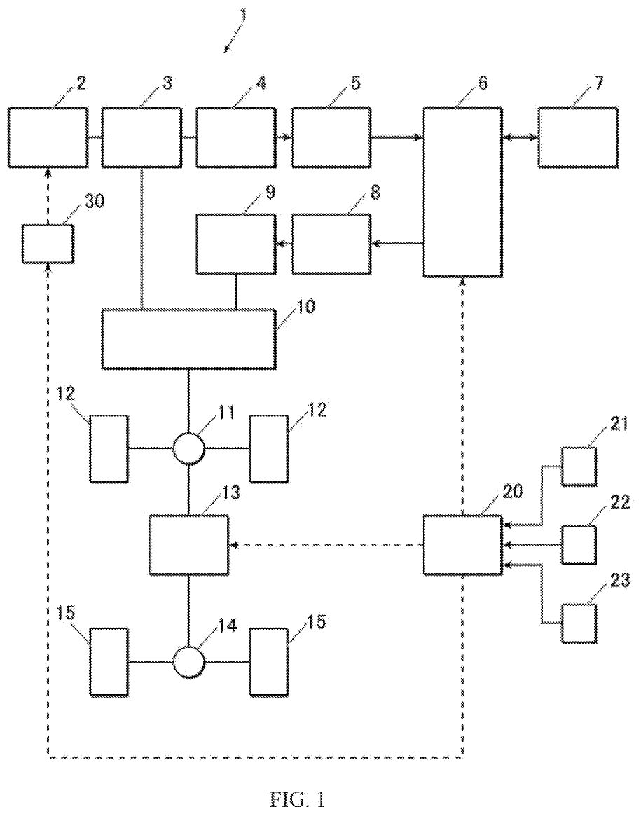

FIG. 1 is a diagram illustrating an example of a configuration of the electric vehicle in which a control apparatus for the electric vehicle according to the example embodiment is mounted. In FIG. 1, a solid line represents a connection of power, an arrow represents a transmission of electric power, and a broken line arrow represents a control system. An arrow between a later-described control apparatus 20 and a wheel speed sensor 21, a gradient detection sensor 22, or a driving operation unit 23 represents a transmission of a signal from the wheel speed sensor 21, the gradient detection sensor 22, or the driving operation unit 23 to the control apparatus 20.

The electric vehicle 1 may include a power dividing mechanism 3 that divides a part of power of the engine 2 and transmits the divided part of the power to a speed reducer 10.

The power dividing mechanism 3 may transmit the remaining divided power to an electric power generation motor 4 to drive the electric power generation motor 4. The thus-driven electric power generation motor 4 may output the generated electric power to an inverter 5 of the electric power generation motor 4. The inverter 5 may convert the electric power into a direct current electric power and output the DC electric power to a step-up converter 6. The step-up converter 6 may adjust the electric power to have an appropriate voltage and store the adjusted electric power in a high-voltage battery 7.

The step-up converter 6 may increase a voltage of the electric power outputted from the high-voltage battery 7 and output the electric power to the inverter 8 of a drive motor 9 on an as-necessary basis, that is, in accordance with an instruction issued from an unillustrated electronic control unit (hereinafter referred to as ECU). The inverter 8 may convert the electric power into an alternating current electric power and output the AC electric power to the drive motor 9 to operate the drive motor 9.

The drive motor 9 may transmit the thus-generated power to the speed reducer 10.

The speed reducer 10 may transmit the power of the engine 2 transmitted from the power dividing mechanism 3 as described above and the power of the drive motor 9 to front wheels 12 via a differential 11.

The electric vehicle 1 according to the example embodiment may thus travel by rotating the wheels (e.g., the front wheels 12) based on the power of the engine 2 and the power of the drive motor 9 operated on an as necessary basis by the electric power outputted from the battery (e.g., the high-voltage battery 7).

The electric vehicle 1 according to the example embodiment may allow the power transmitted from the speed reducer 10 via the differential 11 to be transmitted to rear wheels 15 as well via a differential 14 by operating an electronically controlled coupling mechanism 13.

When the electronically controlled coupling mechanism 13 is not activated, the electric vehicle 1 may be in a drive system based on an FWD (Front-Wheel Drive) drive in which the electric vehicle 1 is driven by the front wheels 12.

When the electronically controlled coupling mechanism 13 is activated, the electric vehicle 1 may be in the drive system based on an AWD (All Wheel Drive) drive in which the electric vehicle 1 is driven by both the front wheels 12 and the rear wheels 15.

The electric vehicle 1 according to the example embodiment may be thus switchable in the drive system of the electric vehicle 1 between the FWD drive and AWD drive depending on whether to activate the electronically controlled coupling mechanism 13.

[Control Apparatus for Electric Vehicle]

The control apparatus 20 for the electric vehicle 1 may be or may include ECU (Electronic Control Unit).

In some embodiments, the control apparatus 20 for the electric vehicle 1 may be the single ECU. In some embodiments, the control apparatus 20 for the electric vehicle 1 may be combined with an engine ECU or any other ECU. It should be noted that the control apparatus 20 for the electric vehicle 1 is hereinafter simply referred to as the control apparatus 20.

As illustrated in FIG. 1, the control apparatus 20 may be coupled to devices including, without limitation, the wheel speed sensor 21, the gradient detection sensor 22, and the driving operation unit 23.

The wheel speed sensor 21 may measure wheel speeds of the front wheels 12 and the rear wheels 15. The gradient detection sensor 22 may be an acceleration sensor, a gravity sensor, or any other suitable sensor, and detect a gradient of a road surface on which the electric vehicle 1 travels or is stopped.

The driving operation unit 23 may have devices including, without limitation, a steering wheel, a shift lever, an accelerator pedal, and a brake pedal which are not illustrated. The driving operation unit 23 may receive a driving operation performed a driver who drives the electric vehicle 1, and output a driving operation signal to the control apparatus 20.

The driving operation signal may include a shift position signal based on an operation of the shift lever. A shift position may include a drive that moves the electric vehicle 1 forward, a reverse that moves the electric vehicle 1 backward, and a parking that holds a stop of the electric vehicle 1.

The control apparatus 20 according to the example embodiment may control the electronically controlled coupling mechanism 13 to switch the drive system of the electric vehicle 1 between the FWD drive and the AWD drive.

In a normal condition, an operation of the electronically controlled coupling mechanism 13 may be controlled by an unillustrated ECU directed to the electronically controlled coupling mechanism 13.

The control apparatus 20 according to the example embodiment may be coupled to the step-up converter 6. When the battery 7 becomes unusable, the step-up converter 6 may notify the control apparatus 20 that the battery 7 becomes unusable.

The control apparatus 20 may start a control when the battery 7 of the electric vehicle 1 becomes unusable.

In addition, the control apparatus 20 may control the step-up converter 6 when the battery 7 of the electric vehicle 1 becomes unusable.

In a normal condition, an operation of the step-up converter 6 may be controlled by an unillustrated ECU directed to the step-up converter 6.

The control apparatus 20 may be coupled to an ECU 30 directed to the engine 2.

The control apparatus 20 may instruct the ECU 30 to increase a rotational speed of the engine 2 to thereby so control the engine 2 as to increase the rotational speed of the engine 2.

[Control performed by Control Apparatus for Electric Vehicle]

Next, examples of a control to be performed by the control apparatus 20 according to the example embodiment will be described.

### [When Battery Becomes Unusable During Traveling]

First, an example of a control to be performed by the control apparatus 20 when the battery 7 becomes unusable during traveling of the electric vehicle 1 will be described.

The control apparatus 20 may start the control when the notification indicating that the battery 7 is not usable is received from the step-up converter 6 as described above.

The control apparatus 20 may cause the step-up converter 6 to output the electric power outputted from the electric power generation motor 4 to the drive motor 9 via the inverter 8, without delivering the electric power outputted from the electric power generation motor 4 to the high-voltage battery 7.

The drive motor 9 may transmit the thus-generated power to, for example, the front wheels 12 via the speed reducer 10. Thus, when the battery 7 becomes unusable during the traveling of the electric vehicle 1, the control apparatus 20 may so change an operation method of the drive motor 9 that the drive motor 9 is directly operated by the electric power generated by the electric power generation motor 4 without intervening the battery 7.

For a purpose of simplifying the description, “directly operating the drive motor 9 by the electric power generated by the electric power generation motor 4 without intervening the battery 7” mentioned above is hereinafter referred to as “directly operating the drive motor 9 by the electric power generation motor 4”.

In addition, the control apparatus 20 according to the example embodiment may switch the drive system of the electric vehicle 1 to the FWD drive when the battery 7 becomes unusable.

For example, when the current drive system of the electric vehicle 1 is the AWD drive, the control apparatus 20 may control the electronically controlled coupling mechanism 13 to switch the drive system of the electric vehicle 1 from the AWD drive to the FWD drive. When the current drive system of the electric vehicle 1 is the FWD drive, the control apparatus 20 may cause the drive system to remain as the FWD drive.

In the example embodiment, one reason why the drive system of the electric vehicle 1 is switched to the FWD drive when the battery 7 becomes unusable is as follows.

For example, if the drive motor 9 is directly operated by the electric power generation motor 4 as described above, the electric power generated by the electric power generation motor 4 can sometimes become unstable in synchronization with the driving of the engine 2 when the power of the engine 2 is unstable.

Accordingly, the power to be generated by the drive motor 9 can sometimes become unstable. In such a case, an operation of the electronically controlled coupling mechanism 13 can possibly become unstable.

Hence, in an above-described case, the electronically controlled coupling mechanism 13 may not be operated, because it is more likely that an operation of the electric vehicle 1 becomes stable when the drive system of the electric vehicle 1 is caused to be the FWD drive instead of causing the drive system of the electric vehicle 1 to be the AWD drive.

[When Battery Becomes Unusable while Electric Vehicle is Stopped on Slope]

When the battery 7 is unusable while the electric vehicle 1 is stopped on a slope, the FWD drive can sometimes be insufficient in power in order to start, in a climbing direction, the electric vehicle 1 stopped on the slope.

Accordingly, the control apparatus 20 according to the example embodiment may switch the drive system of the electric vehicle 1 to the AWD drive when the electric vehicle 1 is determined as being stopped on the slope.

As used herein, starting the electric vehicle 1 in the climbing direction may encompass starting and moving the electric vehicle 1 forward in the climbing direction, and also moving the electric vehicle 1 backward in the climbing direction. For example, starting the electric vehicle 1 in the climbing direction may encompass causing the electric vehicle 1 to move backward in a direction of ascending on the slope.

When the electric vehicle 1 is determined as being stopped on the slope with the battery 7 being unusable as described above, the control apparatus 20 may so change the operation method of the drive motor 9 as to directly operate the drive motor 9 by the electric power generation motor 4 as described above.

In addition, the control apparatus 20 may calculate an amount of electric power necessary to start the electric vehicle 1 in the climbing direction, and so perform a control as to increase the rotational speed of the engine 2 to cause the calculated amount of electric power necessary to be generated by the electric power generation motor 4.

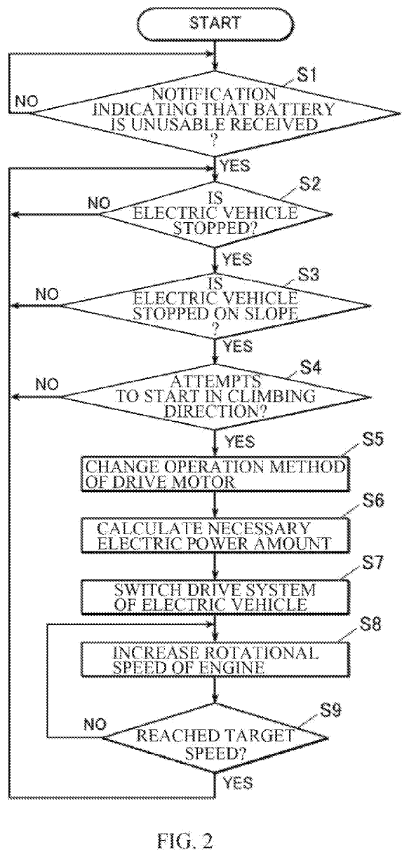

Hereinafter, an example of a control to be performed by the control apparatus 20 will be described in detail based on an example flowchart illustrated in FIG. 2.

It should be noted that a method of controlling the electric vehicle 1 according to an example embodiment will be described together.

The control apparatus 20 may determine whether the electric vehicle 1 is stopped when the battery 7 becomes unusable.

For example, when the control apparatus 20 receives the notification indicating that the battery 7 is unusable from the step-up converter 6 (step S1: YES), the control apparatus 20 may determine whether the electric vehicle 1 is stopped (step S2).

In some embodiments, the control apparatus 20 may determine whether the electric vehicle 1 is stopped, based on the wheel speeds of the front wheels 12 and the rear wheels 15 transmitted from the wheel speed sensor 21.

The control apparatus 20 may determine that the electric vehicle 1 is stopped when the wheel speeds of the front wheels 12 and the rear wheels 15 are all 0 (zero).

When the control apparatus 20 determines that the electric vehicle 1 is stopped (step S2: YES), the control apparatus 20 may thereafter determine whether the electric vehicle 1 is stopped on a slope (step S3).

In some embodiments, the control apparatus 20 may determine whether the electric vehicle 1 is stopped on the slope, based on a signal on a gradient θ transmitted from the gradient detection sensor 22. When an absolute value of the gradient θ is equal to or greater than a predetermined threshold θth, the control apparatus 20 may determine that the electric vehicle 1 is stopped on the slope.

When the control apparatus 20 determines that the electric vehicle 1 is stopped on the slope (step S3: YES), the control apparatus 20 may determine whether the driver attempts to move the electric vehicle 1 forward or backward, based on the driving operation signal transmitted from the driving operation unit 23.

The control apparatus 20 may determine that the driver attempts to start the electric vehicle 1 in the climbing direction, when the driver attempts to move the electric vehicle 1 forward on an uphill slope or attempts to move the electric vehicle 1 backward on a downhill slope, based on the gradient θ (step S4: YES).

As used herein, the term “uphill slope” may refer to a state of a slope where the electric vehicle 1 is stopped with the front wheels 12 being higher in position than the rear wheels 15, and the term “downhill slope” may refer to a state of a slope where the electric vehicle 1 is stopped with the front wheels 12 being lower in position than the rear wheels 15.

The control apparatus 20 may refrain from performing the following example control when the drivers attempt to start the electric vehicle 1 in a direction of descending on the slope (step S4: NO). One reason is that, in this case, the electric vehicle 1 naturally starts in the direction of descending on the slope by gravity without performing the control of increasing the rotational speed of the engine 2.

When the control apparatus 20 determines that the driver attempts to start the electric vehicle 1 in the climbing direction (step S4: YES), the control apparatus 20 may so change the operation method of the drive motor 9 that the drive motor 9 is directly operated by the electric power generation motor 4 as described above (step S5).

For example, the control apparatus 20 may so change the operation method of the drive motor 9 that the drive motor 9 is directly operated by the electric power generated by the electric power generation motor 4 without intervening the battery 7.

In addition thereto, the control apparatus 20 may calculate an electric power amount P necessary to start the electric vehicle 1 in the climbing direction (step S6).

In some embodiments, the control apparatus 20 may calculate the electric power amount P [W], as a product of a climbing resistance R [N] and of a target speed Vt [m/s] upon starting of the electric vehicle 1.

The climbing resistance R may be calculated in accordance with the following Expression (1), based on a vehicle weight W [kg], gravitational acceleration g [m/s²], and the gradient θ [deg] (e.g., the absolute value of the gradient θ) transmitted from the gradient detection sensor 22.

R=W×g×sin θ (1)

The electric power amount P may be calculated in accordance with the following Expression (2).

P=R×Vt (2)

For example, the target speed Vt may be set to any appropriate speed, such as a speed of 5 km per hour (1.4 [m/s]) or a speed of 10 km per hour (2.8 [m/s].

Thereafter, the control apparatus 20 according to the example embodiment may switch the drive system of the electric vehicle 1 to the AWD drive as described above (step S7).

If the current drive system of the electric vehicle 1 is the FWD drive, the control apparatus 20 may switch the drive system of the electric vehicle 1 from the FWD drive to the AWD drive as described above. If the current drive system of the electric vehicle 1 is the AWD drive, the control apparatus 20 may cause the drive system to remain as the AWD drive.

At the same time, the control apparatus 20 may instruct the ECU 30 directed to the engine 2 and thereby so control the engine 2 as to increase the rotational speed [rpm] of the engine 2, such that the electric power amount P thus calculated as described above is generated by the electric power generation motor 4 (step S8).

It should be noted that the operation of the electronically controlled coupling mechanism 13 can possibly become unstable in a state in which the drive motor 9 is to be directly operated by the electric power generation motor 4 as described above.

Accordingly, in some embodiments, the control apparatus 20 may so perform a control as to increase the rotational speed of the engine 2 by taking the time necessary to switch the drive system of the electric vehicle 1 from the FWD drive to the AWD drive, upon increasing the rotational speed of the engine 2.

For example, upon switching the drive system of the electric vehicle 1 from the FWD drive to the AWD drive, the control apparatus 20 may operate the electronically controlled coupling mechanism 13 to cause the power transmitted from the speed reducer 10 via the differential 11 to be transmitted to the rear wheels 15.

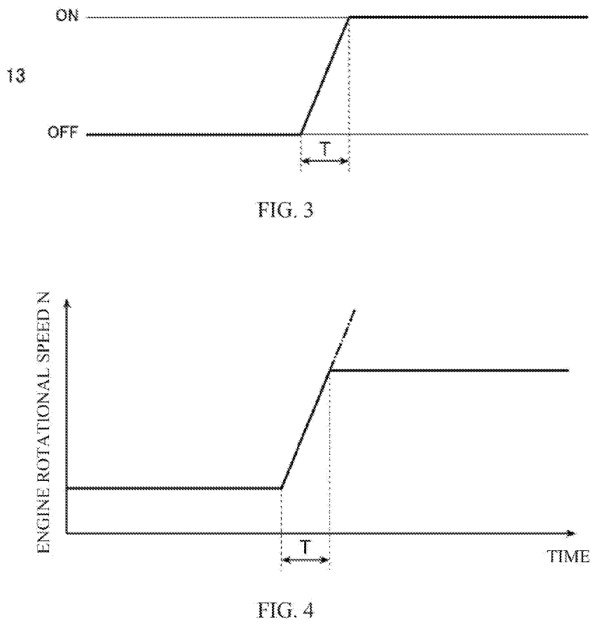

Referring to FIG. 3, it takes time T from a timing when an unillustrated actuator in an OFF state starts operating by the electronically controlled coupling mechanism 13 to a timing when the power is transmitted to the rear wheels 15, i.e., to a timing when the actuator is placed into an ON state. For example, the actuator may be a cylinder.

In such a case, if the rotational speed of the engine 2 is rapidly increased, an operation of the electronically controlled coupling mechanism 13, which becomes unstable when the drive motor 9 is directly operated by the electric power generation motor 4 as described above, can possibly become more unstable.

Accordingly, in some embodiments, the control apparatus 20 may increase a rotational speed N of the engine 2 in response to the degree of transition from OFF to ON of the electronically controlled coupling mechanism 13 illustrated in FIG. 3. For example, upon increasing the rotational speed of the engine 2, the control apparatus 20 may so perform a control that the rotational speed of the engine 2 is increased over the time T necessary to switch the drive system of the electric vehicle 1 from the FWD drive to the AWD drive as illustrated in FIG. 4.

This configuration helps to prevent the operation of the electronically controlled coupling mechanism 13 from becoming unstable as a result of rapidly increasing the rotational speed of the engine 2.

Thereafter, the control apparatus 20 may calculate the speed V of the electric vehicle 1 based on the wheel speeds of the front wheels 12 and the rear wheels 15 transmitted from the wheel speed sensor 21, and determine whether the speed V of the electric vehicle 1 has reached the target speed Vt (step S9).

If the speed V of the electric vehicle 1 has not reached the target speed Vt (step S9: NO), the control apparatus 20 may further increase the rotational speed [rpm] of the engine 2 as denoted by a dashed-dotted line in FIG. 4 (step S8).

In the example embodiment, if the speed V of the electric vehicle 1 reaches the target speed Vt (step S9: YES), the control apparatus 20 may return the process to step S2 because the battery 7 is still unusable.

In some embodiments, when a road surface is no longer the slope and becomes flat after the electric vehicle 1 has started on the slope as described above, the control apparatus 20 may switch the drive system of the electric vehicle 1 from the AWD drive to the FWD drive as described in the section [When Battery becomes Unusable during Traveling].

In the control apparatus 20 for the electric vehicle 1 or the method of controlling the electric vehicle 1 according to the example embodiment described above, the drive motor 9 is directly driven by the electric power generation motor 4 when the electric vehicle 1 is stopped on the slope with the battery 7 being unusable.

In addition, the electric power amount P necessary to start the electric vehicle 1 in the climbing direction is calculated, and the control is so performed as to increase the rotational speed of the engine 2 to cause the electric power amount P to be generated by the electric power generation motor 4.

This configuration helps to increase the rotational speed of the engine 2 and start the electric vehicle 1 in the climbing direction, when the electric vehicle 1 in the battery-less traveling state is stopped on the slope and the electric vehicle 1 is to be moved forward in the climbing direction to start or to be moved backward in the climbing direction.

Accordingly, it is possible to so control the electric vehicle 1 that is in the battery-less traveling state as to start in the climbing direction from the stopped state of the electric vehicle 1 on the slope.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

The control apparatus 20 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the control apparatus 20. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the control apparatus 20 illustrated in FIG. 1.

1. A control apparatus for an electric vehicle, the electric vehicle being configured to store, in a battery, an electric power generated by an electric power generation motor driven by an engine, and being configured to rotate a wheel to travel based on a drive force of the engine and a drive motor configured to operate on an as-necessary basis by an electric power outputted from the battery, the control apparatus for the electric vehicle comprising
circuitry configured to:
upon determining that the electric vehicle is in a state in which the battery becomes unusable and is stopped on a slope, change an operation method of the drive motor to cause the drive motor to be directly operated by the electric power generated by the electric power generation motor without intervening the battery;
calculate an electric power amount necessary to start the electric vehicle in a climbing direction of the slope; and
increase a rotational speed of the engine to cause the necessary electric power amount to be generated by the electric power generation motor.

2. The control apparatus for the electric vehicle according to claim 1, wherein the circuitry is configured to calculate the necessary electric power amount, as a product of a climbing resistance of the slope and of a target speed upon starting of the electric vehicle.

3. The control apparatus for the electric vehicle according to claim 1, wherein the circuitry is configured to:
switch a drive system of the electric vehicle between a front-wheel drive and an all-wheel drive;
switch the drive system to the front-wheel drive when the battery becomes unusable; and
upon determining that the electric vehicle is stopped on the slope, switch the drive system to the all-wheel drive.

4. The control apparatus for the electric vehicle according to claim 3, wherein the circuitry is configured to, upon increasing the rotational speed of the engine, increase the rotational speed of the engine over a time necessary to switch the drive system from the front-wheel drive to the all-wheel drive.

5. A method of controlling an electric vehicle, the electric vehicle being configured to charge, to a battery, an electric power generated by an electric power generation motor driven by an engine, and being configured to rotate a wheel to travel based on a drive force of the engine and a drive motor configured to operate on an as-necessary basis by an electric power stored in the battery, the method comprising:
determining whether the electric vehicle is stopped on a slope when the battery becomes unusable;
when the electric vehicle is determined as being stopped on the slope, changing an operation method of the drive motor to cause the drive motor to be directly operated by the electric power generated by the electric power generation motor without intervening the battery;
calculating an electric power amount necessary to start the electric vehicle in a climbing direction of the slope; and
increasing a rotational speed of the engine to cause the necessary electric power amount to be generated by the electric power generation motor.
